(19) United States
(12) Patent Application Publication
(10) Pub. No.: US 2022/0322439 A1
(43) Pub. Date: Oct. 6, 2022

(54) V2X COMMUNICATION DEVICE AND DATA TRANSMISSION METHOD THEREOF

(71) Applicant: LG ELECTRONICS INC., Seoul (KR)

(72) Inventors: Jongseob BAEK, Seoul (KR); Woosuk KO, Seoul (KR)

(73) Assignee: LG ELECTRONICS INC., Seoul (KR)

(21) Appl. No.: 17/597,067

(22) PCT Filed: Jun. 24, 2019
(86) PCT No.: PCT/KR2019/007599

§ 371 Date: Dec. 23, 2021

(51) Int. Cl. H04W 74/08; H04W 4/40

(52) U.S. Cl. CPC H04W 74/0816; H04W 4/40

(57) ABSTRACT

A method of transmitting data of a V2X communication device is disclosed. The method of transmitting data of the V2X communication device includes measuring a plurality of specific values related to a channel state of a specific channel via a plurality of antenna ports, and each of the plurality of specific values may be measured via each of the plurality of antenna ports. Further, the V2X communication device may determine whether the specific channel is in an idle state based on the plurality of specific values, and, if the specific channel is in the idle state, simultaneously transmit service data to a plurality of adjacent devices via the specific channel using the plurality of antenna ports.

### TECHNICAL FIELD

The present disclosure relates to a device and a data transmission method for V2X communication, and more particularly to a method for transmitting data using a distributed antenna.

### BACKGROUND ART

Nowadays, vehicles are becoming from a product of Mechanical Engineering to a product of complex industrial technology in which electrical technology, electronic technology, and communication technology are fused. In this regard, the vehicle is called a smart car. The smart car connects a driver, a vehicle, and a traffic infrastructure to provide various user customized mobile services as well as traditional vehicle technology, such as traffic safety/jam solution. Such connectivity may be implemented using vehicle to everything (V2X) communication technology. The connectivity may be implemented using various V2X communication technologies such as European ITS-G5, US WAVE, and new radio (NR). The NR may include new inter-vehicle communication technologies developed in the future, including cellular V2X such as LTE-V2X and 5G-V2X.

### DISCLOSURE

### Technical Problem

A design of a multichannel operation (MCO) method using multiple channels is being actively carried out in order to provide various V2X services and distribute V2X traffic loads. In particular, studies on methods for channel selection, channel management, and channel operation considering a traffic load of each channel, quality of each channel, a type and a priority of service provided, etc. are gaining importance. Furthermore, most of the multi-channel operation methods that have been carried out in the past have assumed a V2X system considering a plurality of antennas installed at the same/similar location(s). On the other hand, a distributed antenna V2X system that perform V2X communication using a plurality of antennas installed at different locations (e.g., front bumper/rear bumper/rooftop, side) is recently considered in order to uniformly provide vehicle transmission/reception coverage in an omni directional around the vehicle.

Accordingly, multi-channel selection, channel traffic load management, channel operation method, and the like using channel information, such as channel state information (CSI), a received signal strength indication (RSSI), and a channel busy ratio (CBR), sensed via each antenna in a distributed antenna system are a very important issue in the distributed antenna system.

### Technical Solution

In order to solve the technical problem described above, in one aspect of the present disclosure, there is provided a method of transmitting data of a V2X communication device, the method comprising measuring a plurality of specific values related to a channel state of a specific channel via a plurality of antenna ports, wherein each of the plurality of specific values is measured via each of the plurality of antenna ports; determining whether the specific channel is in an idle state based on the plurality of specific values; and if the specific channel is in the idle state, simultaneously transmitting service data to a plurality of adjacent devices via the specific channel using the plurality of antenna ports.

The method further comprises, if the specific channel is not in the idle state, performing a random back-off procedure.

The random back-off procedure comprises determining whether the specific channel is in the idle state during an arbitrary inter-frame spacing (AIFS) based on a randomly set back-off value; if the specific channel is in the idle state, reducing the back-off value by a predetermined value; and if the back-off value is ‘0’, simultaneously transmitting the service data to the plurality of adjacent devices via the specific channel using the plurality of antenna ports.

The random back-off procedure further comprises, if the specific channel is not in the idle state, determining again whether the specific channel is in the idle state during the AIFS.

The plurality of specific values include a received signal strength indication.

Determining whether the specific channel is in the idle state comprises comparing each of the plurality of specific values with a threshold value; and determining that the specific channel is in the idle state based on a result of comparison.

It is determined that the specific channel is in the idle state when all the plurality of specific values are less than the threshold value.

Determining whether the specific channel is in the idle state comprises comparing a largest value of the plurality of specific values with a threshold value; and if the largest value is less than the threshold value, determining that the specific channel is in the idle state.

In another aspect of the present disclosure, there is provided a V2X communication device comprising a memory configured to store data; an RF unit configured to transmit and receive a radio signal; and a processor configured to control the memory and the RF unit, wherein the processor is further configured to measure a plurality of specific values related to a channel state of a specific channel via a plurality of antenna ports, wherein each of the plurality of specific values is measured via each of the plurality of antenna ports, determine whether the specific channel is in an idle state based on the plurality of specific values, and if the specific channel is in the idle state, simultaneously transmit service data to a plurality of adjacent devices via the specific channel using the plurality of antenna ports.

### Advantageous Effects

The present disclosure can efficiently transmit and receive service data for a V2X system by performing channel selection, channel traffic load management, and channel operation for a distributed antenna system using channel information sensed via each antenna.

The present disclosure can also select an optimum channel for transmitting service data in an omni direction by selecting a channel based on channel information measured via a distributed antenna.

The present disclosure can also sense a state of a channel in an omni direction by sensing respective states of the same channel via distributed antennas.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### DESCRIPTION OF DRAWINGS

The accompany drawings, which are included to provide a further understanding of the present disclosure and are incorporated in and constitute a part of this specification, illustrate embodiments of the present disclosure and together with the description, serve to explain the principles of the present disclosure.

FIG. 1 illustrates a reference architecture of an Intelligent Transport System (ITS) station according to an embodiment of the present disclosure.

FIG. 2 illustrates an ITS access layer according to an embodiment of the present disclosure.

FIG. 3 illustrates multi-channel allocation used for an ITS system operation according to an embodiment of the present disclosure.

FIG. 4 illustrates a channel coordination mode of a multi-channel operation according to an embodiment of the present disclosure.

FIG. 5 illustrates an example of a radiation pattern of a distributed antenna according to an embodiment of the present disclosure.

FIG. 6 illustrates an example of a vehicle network coverage according to an embodiment of the present disclosure.

FIG. 7 illustrates an example of a method for sensing a channel state according to an embodiment of the present disclosure.

FIG. 8 illustrates an example of a back-off procedure based on carrier sensing multiple access with collision avoidance (CSMA/CA) according to an embodiment of the present disclosure.

FIG. 9 illustrates an example of a method of determining an idle state or a busy state of a channel according to an embodiment of the present disclosure.

FIG. 10 illustrates an example of a method for multi-channel selection and multi-channel congestion control in a distributed antenna system.

FIG. 11 illustrates a V2X communication device according to an embodiment of the present disclosure.

FIG. 12 is a flow chart illustrating a method for transmitting data using a distributed antenna according to an embodiment of the present disclosure.

FIG. 13 illustrates an AI device 100 according to an embodiment of the present disclosure.

FIG. 14 illustrates an AI server 200 according to an embodiment of the present disclosure.

FIG. 15 illustrates an AI system 1 according to an embodiment of the present disclosure.

### MODE FOR INVENTION

Preferred embodiments of the disclosure will be described in detail with reference to the accompanying drawings. The following detailed description with reference to the attached drawings illustrates preferred embodiments of the disclosure rather than illustrating only embodiments that may be implemented according to embodiments of the disclosure. The following detailed description includes details in order to provide a thorough understanding of the disclosure, but the disclosure does not require all of these details. In the disclosure, embodiments described hereinafter are not intended to be respectively used independently. Multiple embodiments or all embodiments may be used together, and specific embodiments may be used in combination.

Most of terms used in the disclosure are selected from general ones widely used in the art, but some terms are optionally selected by the applicant and meanings thereof are described in detail in the following description as needed. Accordingly, the disclosure should be understood based on the intended meaning of the term rather than a simple name or meaning of the term.

The disclosure relates to a V2X communication apparatus. The V2X communication apparatus may be included in an intelligent transport system (ITS) system, and may perform some of or all functions of the ITS system. The V2X communication apparatus may perform communication between vehicles, between a vehicle and infrastructure, a vehicle and a bicycle, and may perform communication with a mobile device. The V2X communication apparatus may be abbreviated as a V2X apparatus. In an embodiment, the V2X apparatus may correspond to the on board unit (OBU) of a vehicle or may be included in an OBU. The OBU may be referred to as an on board equipment (OBE). The V2X apparatus may correspond to the roadside unit (RSU) of infrastructure or may be included in an RSU. The RSU may be referred to as a roadside equipment (RSE). Alternatively, the V2X apparatus may correspond to an ITS station or may be included in an ITS station. All of a given OBU, RSU and mobile device that perform V2X communication may be referred to as an ITS station or a V2X communication apparatus.

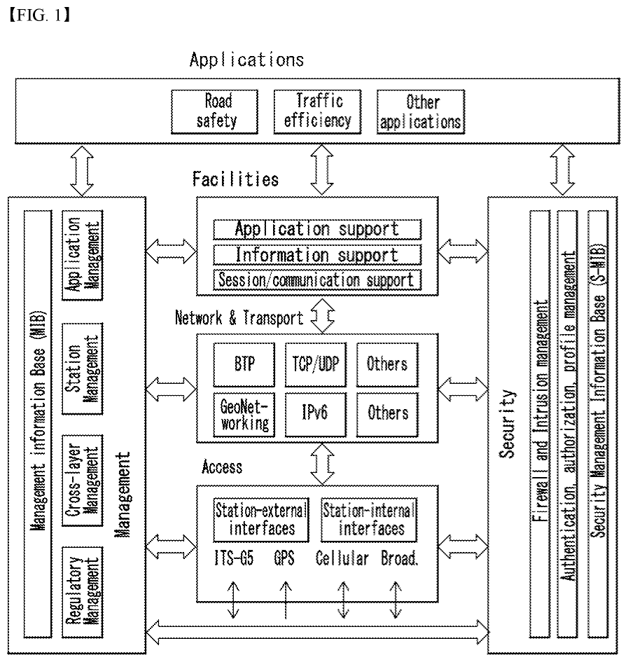

FIG. 1 illustrates a reference architecture of an Intelligent Transport System (ITS) station according to an embodiment of the disclosure.

In the architecture of FIG. 1, two end vehicles/users may communicate with a communication network, and such communication may be performed through a function of each layer of the architecture of FIG. 1. For example, when a message between vehicles is communicated, in a transmitting vehicle and an ITS system thereof, by passing through each layer below one layer, data may be transferred, and in a receiving vehicle and an ITS system thereof, by passing through each layer above one layer, data may be transferred. A description of each layer of the architecture of FIG. 1 is as follows.

Application layer: the application layer may implement and support various use cases. For example, the application may provide road safety, efficient traffic information, and other application information.

Facilities layers: the facilities layer may support to effectively realize various use cases defined at the application layer. For example, the facilities layer may perform application support, information support, and session/communication support.

Networking & Transport layer: the networking/transport layer may constitute a network for vehicle communication between homogenous/heterogeneous networks by using various transport protocols and network protocols. For example, the networking/transport layer may provide Internet access and routing using an Internet protocol such as TCP/UDP+IPv6. Alternatively, the networking/transport layer may constitute a vehicle network using a geographical position based protocol such as Basic Transport Protocol (BTP)/GeoNetworking.

Access layer: the access layer may transmit a message/data received from a superordinate layer through a physical channel. For example, the access layer may perform/support data communication based on IEEE 802.11 and/or 802.11p standard based communication technology, ITS-G5 wireless communication technology based on IEEE 802.11 and/or 802.11p standard physical transmission technology, 2G/3G/4G(LTE)/5G wireless cellular communication technology including satellite/broadband wireless mobile communication, broadband terrestrial digital broadcasting technology such as DVB-T/T2/ATSC, GPS technology, and IEEE 1609 WAVE technology.

ITS architecture may further include a management layer and a security layer.

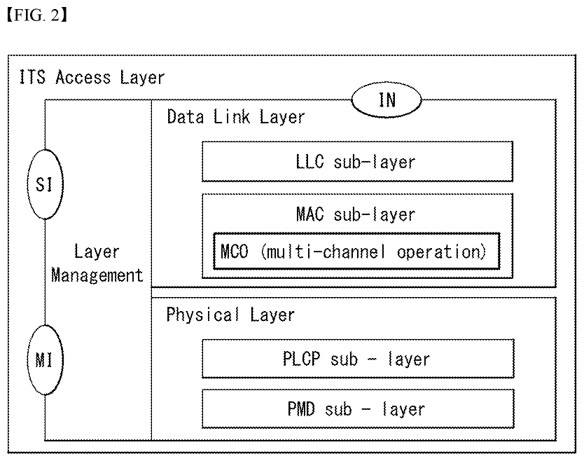

FIG. 2 illustrates an ITS access layer according to an embodiment of the disclosure.

FIG. 2 illustrates in more detail the ITS Access Layer of the ITS system of FIG. 1. The access layer of FIG. 2 may include a data link layer, a physical layer, and layer management. The access layer of FIG. 2 has characteristics similar to or identical to an OSI 1 layer (physical layer) and an OSI 2 layer (data link layer).

The data link layer may include a Logical Link Control (LLC) sub-layer, a Medium Access Control (MAC) sub-layer, and a Multi-channel operation (MCO) sub-layer. The physical layer may include a Physical Layer Convergence Protocol (PLCP) sub-layer and a Physical Medium Access (PMD) sub-layer.

In order to enable a superordinate network layer to use a physical line between adjacent nodes (or between vehicles) having noise, the data link layer may convert the physical line into a communication channel having no transmission error. The data link layer performs a function of transmitting/transporting/transferring a 3-layer protocol, a framing function of dividing and grouping data to transmit into a packet (or frame) as a transmission unit, a flow control function of compensating a speed difference between the sending side and the receiving side, and a function of detecting and modifying or retransmitting a transmission error. Further, the data link layer performs a function of giving a sequence number to a packet and an ACK signal in order to avoid to erroneously confuse the packet or the ACK signal and a function of controlling setting, maintaining, short-circuit, and data transmission of a data link between network entities. Furthermore, such a data link layer may include a logical link control (LLC) sub-layer and a medium access control (MAC) sub-layer based on IEEE 802 standard.

A main function of the LLC sub-layer is to enable to use several different sub-MAC sub-layer protocols to allow communication unrelated to topology of a network.

The MAC sub-layer may control occurrence of collision/contention between vehicles when several vehicles (or nodes or a vehicle and peripheral devices) use a shared medium. The MAC sub-layer may format a packet transferred from a superordinate layer to correspond to a frame format of the physical network. The MAC sub-layer may perform addition and identification functions of a sender address/recipient address, carrier detection, collision detection, and fault detection on a physical medium.

The physical layer: the physical layer may define an interface between a node and a transmission medium to a lowest layer on an ITS layer structure and perform modulation, coding, and mapping of a transmission channel to a physical channel for bit transmission between data link layer entities. Further, the physical layer performs a function of notifying the MAC sub-layer whether a wireless medium is being used (busy or idle) through carrier sense and clear channel assessment (CCA). Furthermore, such a physical layer may include a physical layer convergence protocol (PLCP) sub-layer and a physical medium access (PMD) sub-layer based on IEEE standard.

The PLCP sub-layer performs a function of connecting a data frame with the MAC sub-layer. By attaching a header to the received data, the PLCP sub-layer enables to operate the MAC sub-layer regardless of physical characteristics. Therefore, in the PLCP frame, a format thereof may be defined differently according to various different wireless LAN physical layer standards.

A main function of the PMD sub-layer may perform carrier/RF modulation of frames received from the PLCP sub-layer and then transmit the frames to a wireless medium according to transmission and reception transmission related standards.

Layer management performs a function of managing and servicing information related to an operation and security of an access layer. Information and service are bilaterally transferred and shared through MI (interface between management entity and access layer or MI-SAP) and SI (interface between security entity and access layer or SI-SAP). Two-way information and service transfer between the access layer and a network/transport layer is performed by IN (or IN-SAP).

The MCO sub-layer may provide various services such as a safety service and other services, i.e., a non-safety service other than the safety service using a plurality of frequency channels. By effectively distributing a traffic load in a particular frequency channel to other channels, the MCO sub-layer may minimize collision/contention when communicating between vehicles in each frequency channel.

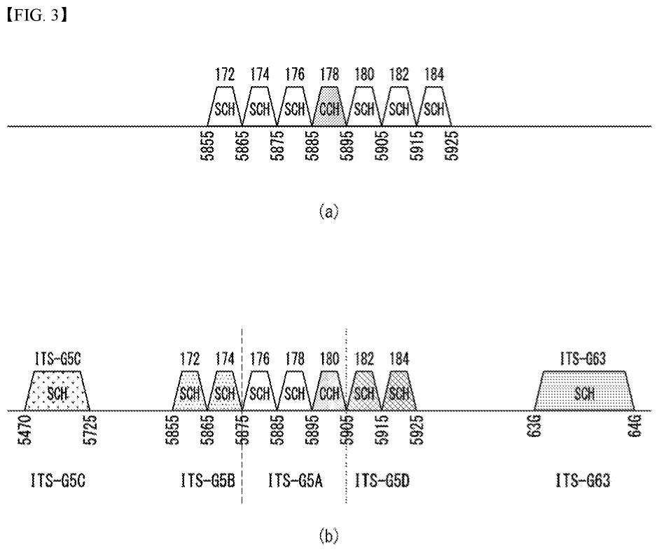

FIG. 3 illustrates multi-channel allocation used for an ITS system operation according to an embodiment of the disclosure.

FIG. 3(a) illustrates US spectrum allocation for an ITS, and FIG. 3(b) illustrates EP spectrum allocation for an ITS.

As shown in FIG. 3, the United States and Europe have seven frequencies (each frequency bandwidth: 10 MHz) in 5.9 GHz band (5.855 to 5.925 GHz). Seven frequencies may include one CCH and 6 SCHs. As shown in FIG. 3(a), in the United States, the CCH is allocated to a channel number 178 and as shown in FIG. 3(b), in European, the CCH is allocated to a channel number 180.

In Europe, in order to provide a service that is time-sensitive and has a large data capacity, it is considered to additionally use an ITS-G63 band in a superordinate frequency band based on 5.9 GHz and to use an ITS-G5 band in a subordinate frequency band. An efficient multi-channel operation method needs to be developed to provide high-quality service by appropriately allocating the service to various multi-channels in such an environment.

The CCH indicates a radio channel used for the exchange of a management frame and/or a WAVE message. The WAVE message may be a WAVE short message (WSM). The SCH is a radio channel used for providing a service and represents a random channel instead of the CCH. In an embodiment, the CCH may be used for communication of a Wave Short Message Protocol (WSMP) message or communication of a system management message such as a WAVE Service Advertisement (WSA). The SCH may be used for general-purpose application data communication, and the communication of such general-purpose application data may be coordinated by service-related information such as WSA.

Hereinafter, the WSA may be also referred to as service advertisement information. The WSA is an application may provide information including announcement of availability of an application-service. A WSA message may identify and describe an application service and a channel in which the service is accessible. In an embodiment, the WSA may include a header, service information, channel information, and WAVE routing advertisement information.

Service advertisement information for service access may be a periodic message. In an embodiment, Co-operative Awareness Messages (CAM) may be periodic messages. The CAM may be broadcasted periodically by a facilities layer.

Decentralized Environmental Notification Messages (DENM) may be event messages. The event message may be triggered by detection of the event to be transmitted. Service messages may be transmitted to manage a session. In the following embodiments, the event message may include a security message/information. The service message may include a non-safety message/information.

A V2X communication device may broadcast a cooperative awareness message (CAM) or a decentralized environmental notification message (DENM).

The CAM is distributed in an ITS network, and provide information on at least one of the presence, location or communication state of the ITS station. The DENM provides information on a detected event. The DENM may provide information on a given driving condition or event detected by an ITS station. For example, the DENM may provide information on a situation, such as an emergency electronic brake, a vehicle accident, a vehicle problem or a traffic condition.

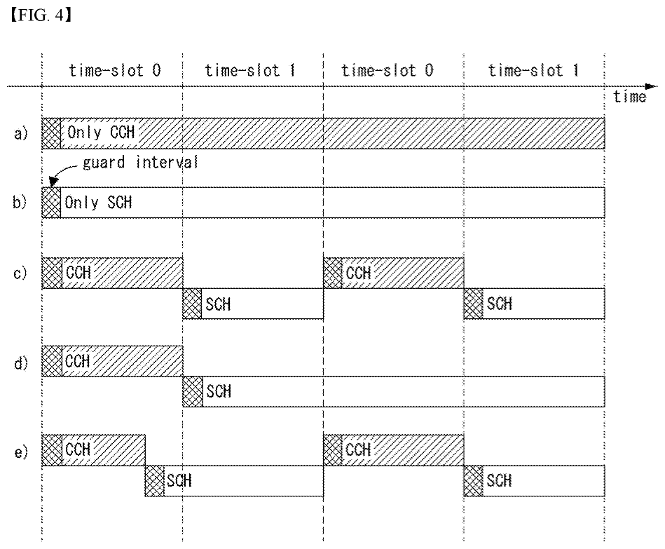

FIG. 4 illustrates a channel coordination mode of a multi-channel operation according to an embodiment of the present disclosure.

FIG. 4 illustrates (a) a continuous mode, (b) an altering mode, (c) an extended mode, and (d) an immediate mode, that is, channel coordination modes of a multi-channel operation. The channel coordination mode may indicate a method that a V2X device accesses a CCH and an SCH.

A V2X device may access at least one channel. In an embodiment, one radio device may monitor a CCH and exchange data via an SCH. For this purpose, a channel interval needs to be specified. FIG. 4 shows such a channel interval, that is, time slot allocation. Radio channel altering may be performed based on a synchronized interval in association with a common time base. The sync interval may include a plurality of time slots. Furthermore, the plurality of time slots may correspond to a CCH interval and an SCH interval. In such a case, the sync interval may include a CCH interval and an SCH interval. Traffic may be exchanged in a CCH during the CCH interval. A single-radio device participating in application-service may switch to an SCH during an SCH interval. Each of the CCH interval and the SCH interval may include a guard interval. Each interval may start with a guard interval.

In an embodiment, the exchange of multi-channel operation information and safety-related services information may be performed in a CCH during a CCH interval. Furthermore, negotiation for information exchange between a service provider and a user may be performed in a CCH during a CCH interval. A hardware timing operation for the channel altering of a V2X device may be initiated by a sync signal obtained through universal time coordinated (UTC) estimation. A channel sync may be performed every 1 pulse per second (PPS) section based on UTC.

In an embodiment, FIG. 4 is a channel coordination method of a multi-channel operation (MCO) described in IEEE 1609.4, and shows a method in which in a single physical layer, two MAC layers divide time and alternately use a CCH and different channel modes.

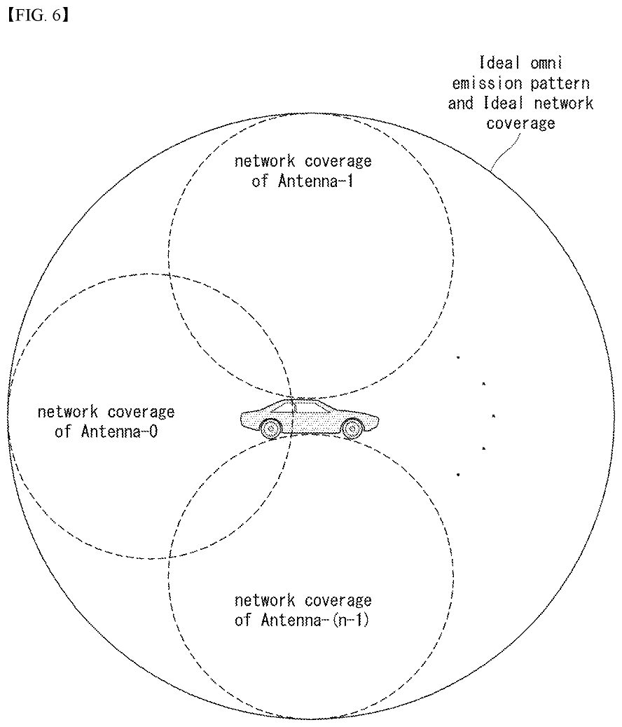

(a)&(b) continuous mode: the continuous mode is a mode in which each vehicle or all vehicles operate regardless of a time division basis, such as the time slot/CCH interval/SCH interval of FIG. 6. In the continuous mode, a V2X device may continuously receive operation information and safety-related services information of a multi-channel in a designated CCH or SCH, or an information exchange may be performed between a service provider and a user.

(c) altering mode: in the altering mode, each vehicle or all vehicles may receive operation information and safety-related services/information of a multi-channel during a CCH interval or may perform a negotiation process for an information exchange between a service provider/user. In the altering mode, each vehicle or all vehicles perform a service/information exchange between a service provider and a user during an SCH interval. In the altering mode, V2X devices may alternately perform communication through a CCH and an SCH during a configured CCH interval and SCH interval.

(d) extended mode: in the extended mode, communication during a CCH interval and an SCH interval may be performed as in the altering mode. However, a service/information exchange during an SCH interval may also be performed in a CCH interval. In an embodiment, a V2X device in the extended mode may transmit and receive control information during a CCH interval, and may maintain an SCH interval until the exchange of service/information is terminated when it enters the SCH interval.

(e) immediate mode: in the immediate mode, the communication of a V2X device may be performed as in the altering mode and/or the extended mode. However, a V2X device in the immediate mode may immediate change a channel to a designated SCH without waiting for the end of a CCH interval when negotiation for an information exchange is completed during the CCH interval, and may initiate an information exchange. As shown in FIG. 4, the extended mode and the immediate mode may be used together.

In the case of the channel coordination modes shown in FIG. 4, management information of a multi-channel and information exchange and negotiation for service provision may be performed only in a CCH during a CCH interval. Negotiation for receiving safety-related services and information or for an information exchange between a service provider and a user may also be performed only in a CCH during a CCH interval.

A guard interval may be included between a CCH interval and an SCH interval. The guard interval may enable a communication device to secure the time necessary for sync upon performing frequency altering and channel altering. Upon channel altering, a hardware timer operation may be started by a sync signal obtained through universal time coordinated (UTC) estimation. A channel sync may be synchronized every 1 pulse per second (PPS) section using UTC as a reference signal.

In an embodiment, a sync interval may include a CCH interval and an SCH interval. That is, one sync interval may include two time slots. The CCH interval and the SCH interval may correspond to a time slot 0 and a time slot 1, respectively. The start of a sync interval may be identical with the start of a common time reference second. A sync interval that is a positive number times may be included for 1 second.

The V2X communication apparatus may perform communication using a multichannel operation (MCO) technology using multiple antennas. In an embodiment, the ETSI MCO design described in ETSI TS 102 646-4-2 is designed by chiefly considering the following items.

A channel access (CA) method capable of effectively using a channel resource using a multi-antenna in a multi-channel needs to be provided.

A mechanism for enabling the V2X apparatus to effectively receive a service announcement message (SAM) that provides V2X service information and to move to a channel in which a corresponding service is provided needs to be provided.

A mechanism for minimizing an interference influence between adjacent channel which may occur when V2X transmission and reception using two or more multiple antennas and adjacent channels are performed in the same vehicle at the same time needs to be provided.

A control channel (CCH) is a basic channel in which a message related to traffic safety, such as a cooperative awareness message (CAM), a decentralized environmental notification message (DENM), a topology (TOPO), or a MAP, is provided. A safety message that has not been sufficiently provided in a CCH may be provided through an SCH. If a new type of a safety message is added, the added safety message may be provided in an SCH.

V2X services provided through a service channel (SCH) are announced through an SAM. The SAM may be provided through a well-known reference channel. For example, V2X service information provided in a channel band, such as ITS-G5A/B/D, may be provided through an SAM in a reference CCH. In this case, services may not be provided in the CCH because the provision of V2X services through the CCH may affect a safety message. V2X service information provided in each channel band may be provided through an SAM in an alternate reference SCH randomly designated within a channel band.

A design of a multichannel operation (MCO) method using multiple channels is being carried out in order to provide various V2X services and distribute V2X traffic loads. In the multi-channel operation, methods for channel selection, channel management, and channel operation considering a traffic load of each channel, quality of each channel, and a type and a priority of service provided are important. In a single/multi-hop communication operation using a multi-channel, various scenarios requiring a channel selection/change may be expected. The channel selection/change may be performed in a vehicle or a road side unit (RSU).

Safety/non-safety service provision-related channel selection may be required. If there is a primary channel/designated primary channel with a high priority for corresponding service, a V2X communication device may preferentially select the primary channel as a default channel. There may be no designated primary channel for service. If there is no designated primary channel for service, the V2X communication device cannot perform the channel selection since there is no default channel for service in which the primary channel has not been defined. In this case, a channel initially selected for the service may be considered as the primary channel. In the present disclosure, the primary channel refers to a channel previously designated for service provision. A secondary channel refers to an available channel other than the primary channel and means a channel that has not been previously designated for service provision.

A safety/non-safety service provision-related channel change may be required. If there is a primary channel for corresponding service, the primary channel may be preferentially selected and used, but there may be a case where a channel change is necessary because the channel is congested or a secondary channel with a better transmission environment is present. There may also be a case where the changed secondary channel is used, and then a channel change is necessary again if the channel is congested or a secondary channel with a better transmission environment is present. There may also be a case where the secondary channel is used, and then a channel change is necessary again if the channel is congested or a primary channel with a better transmission environment is present. If there is no primary channel for corresponding service, there may be a case where a channel change into a secondary channel is necessary because a state of a channel that is preferentially selected and used becomes congested.

In V2X communication, a design of a multichannel operation (MCO) method using multiple channels is being actively carried out in order to provide various services and distribute traffic loads. In particular, studies on methods for channel selection, channel management, and channel operation considering a traffic load of each channel, quality of each channel, a type and a priority of service provided, etc. are gaining importance. Furthermore, most of the multi-channel operation methods that have been carried out in the past have assumed a V2X system considering a plurality of antennas installed at the same/similar location(s). On the other hand, a distributed antenna V2X system that perform V2X communication using a plurality of antennas installed at different locations (e.g., front bumper/rear bumper/rooftop, side) is recently considered in order to uniformly provide vehicle transmission/reception coverage in an omni directional around the vehicle.

Hence, multi-channel selection, channel traffic load management, channel operation method, and the like using channel information, such as channel state information (CSI), a received signal strength indication (RSSI), and a channel busy ratio (CBR), sensed via each antenna in a distributed antenna system require an enhanced research considering the distributed antenna system.

Accordingly, the present disclosure proposes a method of selecting resources for efficiently broadcasting the same safety/non-safety message in a CSMA/CA based distributed antenna V2X system.

In the present disclosure, a CSMA/CA back-off procedure refers to a method of selecting resources performed for broadcasting the same message in each distributed antenna, and channel state information means a method of measuring channel state information finally from a vehicle coverage perspective using received signal strength indicator information measured in each distributed antenna.

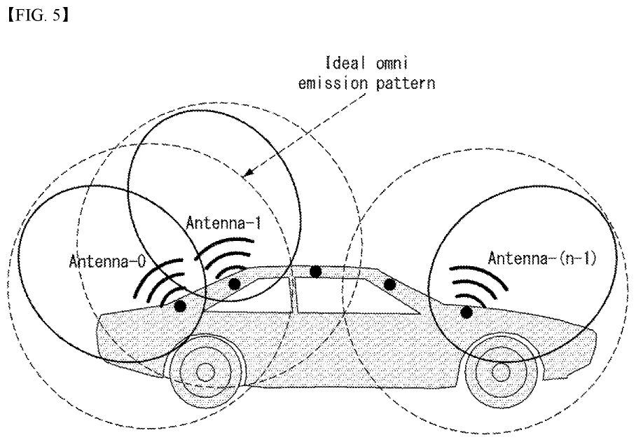

FIG. 5 illustrates an example of a radiation pattern of a distributed antenna according to an embodiment of the present disclosure.

Referring to FIG. 5, because a coverage of an antenna may be actually changed due to the movement of the vehicle and obstacles or surrounding vehicles, an area where communication is not possible may occur in a vehicle.

Specifically, in V2X communication, antennas installed at different locations may form different antenna radiation patterns depending on self-blocking and reflection of a vehicle body, an antenna installation location, and an angle of surface, etc.

In FIG. 5, a portion marked with the dotted line denotes an ideal omni-directional emission pattern for each antenna of the vehicle, and the solid line denotes an example of an actual radiation pattern distorted due to interference from the vehicle itself and its surroundings.

As illustrated in FIG. 5, an emission pattern of each distributed antenna installed in the vehicle may have an omni-directional antenna emission pattern.

That is, although each antenna has the omni-directional antenna emission pattern, the complete omni-directional antenna emission pattern illustrated by the dotted line in FIG. 5 may fail to be provided consequentially depending on the interference of the vehicle itself, the installation position of the antenna, and the angle of the plane, etc.

Accordingly, there is a need to design distributed antennas through the arrangement of a plurality of antennas so that the vehicle in the V2X communication has an ideal coverage considering the emission pattern.

FIG. 6 illustrates an example of a vehicle network coverage according to an embodiment of the present disclosure.

Referring to FIG. 6, as the number of distributed antennas, in which a plurality of antennas is disposed in the vehicle, increases, a communication coverage of the vehicle may approach an ideal omni-directional network coverage.

Specifically, in order to form an ideal omni-directional emission pattern suitable for a V2X system that sends the same message to adjacent devices through a broadcasting method, the plurality of antennas shall be distributed and installed at suitable locations of the vehicle.

That is, the plurality of antennas shall be distributed and installed at regular intervals or different intervals so that the ideal antenna pattern is formed through the plurality of antennas considering the substantial antenna emission pattern illustrated in FIG. 5.

In this case, if a resource for broadcasting is selected using CSMA/CA in the V2X system using the distributed antenna illustrated in FIGS. 5 and 6, resources based on common channel state sensing information shall be selected and used in order to efficiently broadcast the same message.

If the plurality of antennas are used for the emission pattern, a channel state measured by each antenna even in the same channel may be changed depending on a direction of the antenna and an environment in which the antenna is located.

Accordingly, even in the same channel, even if the same channel at a specific antenna is measured as an idle state, the same channel at another antenna may be measured as a busy state.

That is, the respective antennas distributed and installed in the vehicle may provide different radiation patterns and network coverages, and as a result, may have different channel state information (CSI), such as CSI, RSSI, and channel busy ratio (CBR). If the CSMA/CA is performed using the different channel state information, resources selected via the respective antennas may be different from each other. Therefore, there is a problem in that resource utilization is inefficient from a perspective of transmitting the same message.

Accordingly, the present disclosure proposes a method of determining a channel state from a vehicle coverage perspective rather than determining a channel state from a perspective of each antenna, in order to acquire common channel state sensing information from a channel state measured via each of the plurality of distributed antennas.

The present disclosure also proposes a method for processing different channel methods obtained from each of the distributed antennas in order to determine a channel state from a vehicle coverage perspective.

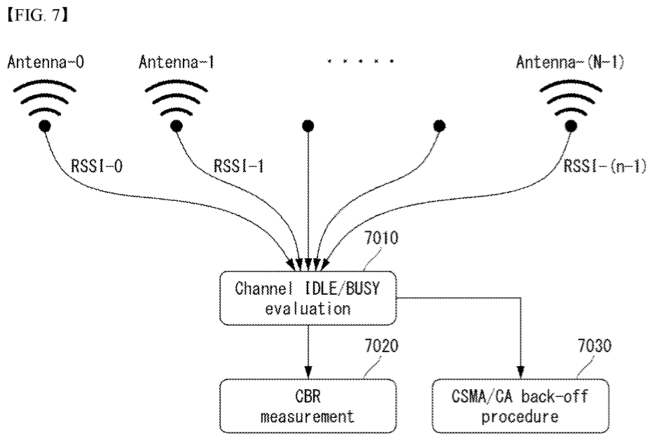

FIG. 7 illustrates an example of a method for sensing a channel state according to an embodiment of the present disclosure.

Referring to FIG. 7, a channel state from a vehicle coverage perspective may be determined using different channel information acquired from each distributed antenna.

Specifically, a vehicle may sense a specific channel via respective antennas (Antenna-0 to Antenna-(N−1)) and acquire channel state information representing a channel state in order to broadcast service data.

In this instance, the channel state information may use various values, and is described below using a received signal strength indication as an example.

Next, the vehicle may determine whether the specific channel is in an idle state or a busy state based on RSSI values obtained via the respective distributed antennas from the vehicle coverage perspective, through a channel IDLE/BUSY block 7010.

If the specific channel is in the idle state from the vehicle coverage perspective, the vehicle may broadcast the service data via the specific channel. If the specific channel is in the busy state, the vehicle may sense again another channel or sense again the same channel through a back-off procedure to be described below.

Next, channel state information of the specific channel may be delivered to a CBR measurement block 7020 and/or a CSMA/CA back-off procedure block 7030, in order to calculate the CBR for selecting the resource for service data transmission.

As described above, the vehicle may determine the channel state from the vehicle coverage perspective using channel state information acquired via each antenna of the vehicle, in which the distributed antennas are installed, and select the resource based on this to broadcast service data via the plurality of antennas at the same time.

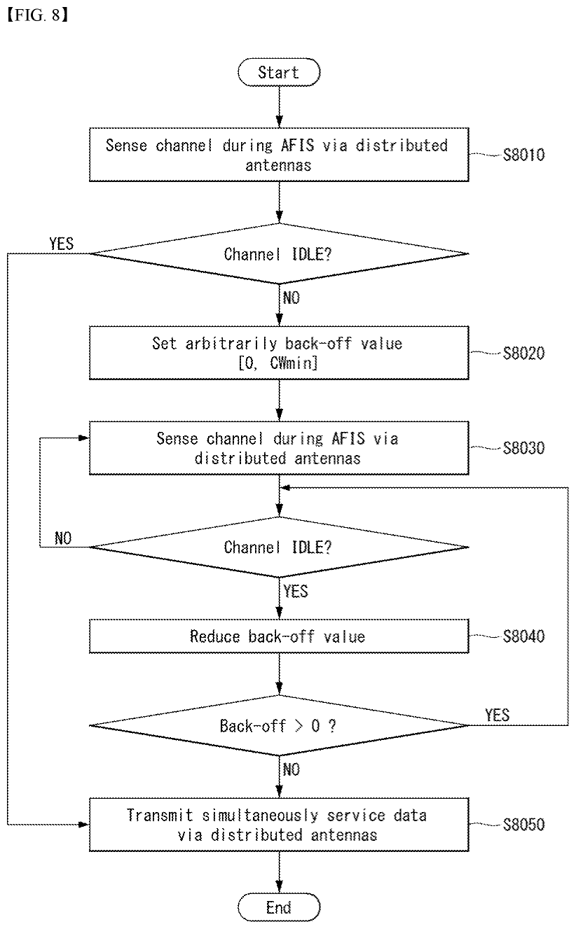

FIG. 8 illustrates an example of a back-off procedure based on carrier sensing multiple access with collision avoidance (CSMA/CA) according to an embodiment of the present disclosure.

Referring to FIG. 8, the vehicle may check the idle state of the channel from the vehicle coverage perspective using channel state information acquired via the distributed antenna, and thus may broadcast service data in the resource selected through the back-off procedure.

Specifically, if a CSMA/CA functionality via the distributed antenna of the vehicle is “ON”, the vehicle may determine an idle state or a busy state of the channel from the vehicle coverage perspective via the distributed antenna and perform the back-off procedure for transmitting service data.

First, the vehicle may sense a channel during an arbitration inter-frame spacing (AFIS) via the distributed antennas that are installed in the vehicle at regular intervals or different intervals, in S8010.

The AFIS indicates a duration in which the communication device waits before allowing transmission in a next frame. A shorter AFIS period may mean that the message is sent with a higher probability at a lower latency.

That is, the AFIS refers to a duration in which the communication device waits before transmission of a frame, and the vehicle may sense the channel state of the specific channel during the AFIS duration and obtain a specific value (e.g., RSSI, CSI, etc.) representing the channel state.

The vehicle may determine whether the channel is in the idle state or the busy state from the vehicle coverage perspective described above using a specific value representing the plurality of acquired channel states. A method of determining the idle state/busy state of the specific channel is described below.

Next, if the vehicle determines that the specific channel is in the idle state from the vehicle coverage perspective, the same message may be sent (broadcasted) from each of the plurality of distributed antennas via the specific channel, in S8050.

However, if the vehicle determines that the specific channel is in the busy state from the vehicle coverage perspective, the vehicle may perform a random back-off procedure. That is, if the specific channel is in the busy state, the vehicle may arbitrarily set a back-off value and sense again the same or a different channel, in S80201.

In this instance, in order to minimize a message collision due to simultaneous transmission of messages between the vehicles, a back-off value indicating a value waiting before the message transmission in each vehicle may be arbitrarily selected and set in a contention window (CW) duration (e.g., [0, CW min] duration).

The vehicle may sense again the channel during the AFIS via the distributed antennas in a set backoff duration, in S8030.

That is, the vehicle may acquire a value representing the state of the channel from the channel or other channel, that is determined to be in the busy state, in the set backoff duration during the AFIS via the distributed antenna.

If it is determined that the channel state is again the busy state, the vehicle may obtain again a value representing the channel state during the AFIS via the distributed antenna until a duration according to the set back-off value ends, and determine again the idle state/busy state of the channel through the obtained values.

However, if it is determined that the channel state is the idle state, the vehicle reduces the set back-off value because the vehicle does not perform an operation for transmitting service data during a duration according to the set back-off value and shall wait, in S8040.

For example, when the back-off value is set to a value representing the number of specific time slots in which the vehicle must wait, if it is determined that the measured state of the channel is the idle state, the vehicle may reduce the number of time slots represented by the back-off value by ‘1’ until the set back-off value reaches ‘0’.

If the back-off value is not ‘0’, the vehicle may determine again whether the channel is in the idle state in the time slot represented by the reduced back-off value. If the channel is in the idle state, the vehicle may reduce again the back-off value.

If the back-off value is ‘0’, the vehicle may broadcast simultaneously the same message via the respective distributed antennas on the selected channel, in S8050.

The vehicle may determine whether the channel is in the idle state from the vehicle coverage perspective via the distributed antennas through the above-described method, and each of the distributed antennas may simultaneously broadcast the message on the same resource selected depending on whether the channel is in the idle state.

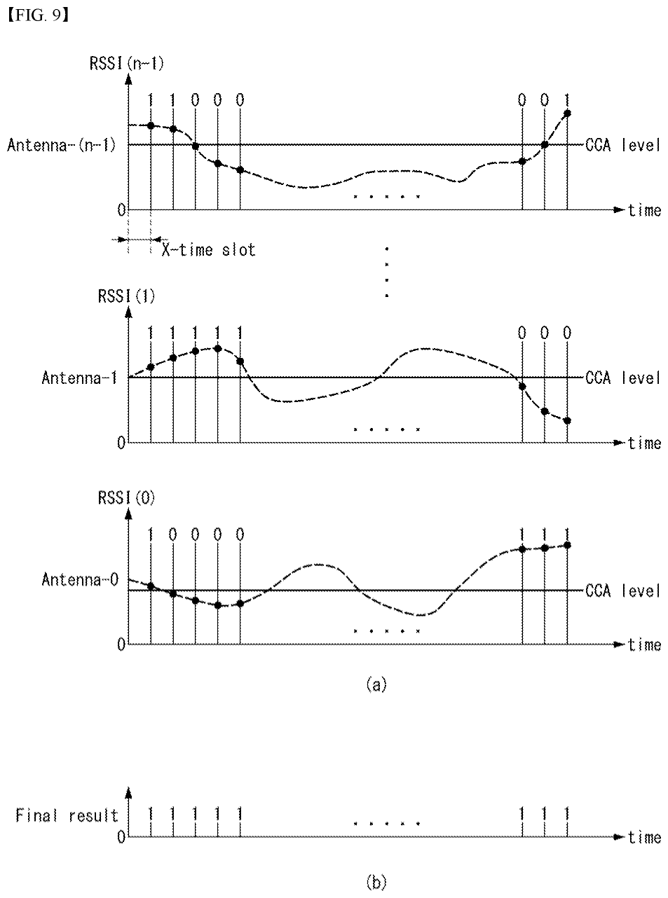

FIG. 9 illustrates an example of a method of determining an idle state or a busy state of a channel according to an embodiment of the present disclosure.

Referring to FIG. 9, the vehicle may determine whether the channel is in the idle state using a representative value of the channel state obtained via each antenna or all the channel state information.

First, in order to determine whether the channel is in the idle state/busy state, the number and location of distributed antennas may be properly set so that an omni directional vehicle network coverage for broadcasting the same message is the ideal vehicle coverage illustrated in FIGS. 5 and 6.

That is, the appropriate number of distributed antennas shall be installed in the vehicle at regular intervals or different intervals so that the ideal coverage is formed from the vehicle perspective illustrated in FIGS. 5 and 6.

It is assumed that surrounding vehicles within the vehicle network coverage of the vehicle broadcasting the message are uniformly distributed.

The vehicle may determine the idle state/busy state of the channel from the vehicle coverage perspective using a plurality of channel state information (e.g., binary information for RSII information or RSSI, etc.) acquired via each of the distributed antennas through the method illustrated in FIGS. 7 and 8.

First, the vehicle may measure the channel state information, i.e., RSSI via each distributed antenna, or acquire binary information for the RSSI from the measured RSSI. In this instance, the binary information for the RSSI is information representing the channel state. As illustrated in (a) of FIG. 3, if the RSSI measured during x-time slot is greater than a specific threshold value (e.g., channel clear assessment (CCA)), the binary information is set to a value of ‘1’ representing that the channel is in the busy state.

However, if the measured RSSI is less than the specific threshold value, the binary information for the RSSI is set to a value of ‘0’ representing that the channel is in the idle state.

Next, the vehicle finally determines the channel state from the vehicle coverage perspective through the following method using the RSSI value (or binary information for RSSI) measured from each distributed antenna.

First, if the vehicle determines the channel state from the vehicle coverage perspective using RSSI information measured from respective antennas of a synchronized distributed antenna system, the vehicle may select the largest value among RSSI values (or RSSI information) collected from each antenna during the x-time slot through the following equation.

$$RSSI = {max}_{i} ( {RSSI}_{( i )} ) , for i = 0 , … , n - 1 \qquad [ Equat ion 1 ]$$

Next, the vehicle compares the selected RSSI value with a specific threshold value to determine that the channel state is the busy state if the selected RSSI value is greater than the specific threshold value and to determine that the channel state is the idle state if the selected RSSI value is less than the specific threshold value.

Secondly, if the vehicle determines the channel state from the vehicle coverage perspective using binary information of RSSI acquired from respective antennas of a synchronized distributed antenna system, the vehicle, as illustrated in (a) of FIG. 9, checks whether there is binary information with a value of ‘1’ among binary information of RSSI acquired from each antenna during the x-time slot.

As illustrated in (b) of FIG. 9, if there is at least one binary information with a value of ‘1’ among the binary information acquired from each antenna during the x-time slot, it represents that the channel at some of the plurality of distributed antennas is in the busy state. Therefore, the vehicle determines that the channel is in the busy state from the vehicle coverage perspective.

That is, if it is determined that the selected channel even at some of the plurality of distributed antennas is in the busy state, the vehicle shall select another channel (or resource) in the antenna in which the channel is in the busy state, and send a message. Therefore, the vehicle may determine that the channel is in the busy state from the vehicle coverage perspective.

For example, in (a) of FIG. 9, if binary information acquired from each distributed antenna during the x-time slot is “0, 0, 0, . . . , 0, 1”, the vehicle may determine that the channel state is the busy state.

However, if there is no binary information with a value of ‘1’ among binary information acquired from each distributed antenna during the x-time slot, it represents that the channels at all the plurality of distributed antennas are in the idle state. Therefore, the vehicle may determine that the channel is in the idle state from the vehicle coverage perspective, and send simultaneously the same message via the plurality of distributed antennas at the selected channel.

The vehicle may determine whether the common channel is in the idle state from the vehicle coverage perspective via the distributed antennas using the method described above.

In the following is described a method of measuring a CBR from a vehicle coverage perspective that can be used for multi-channel selection and multi-channel congestion control in a V2X system of distributed antennas as another embodiment of the present disclosure.

First, in order to calculate the CBR, the number and location of distributed antennas may be properly set so that an omni directional vehicle network coverage for broadcasting the same message is the ideal vehicle coverage illustrated in FIGS. 5 and 6.

That is, the appropriate number of distributed antennas shall be installed in the vehicle at regular intervals or different intervals so that the ideal coverage is formed from the vehicle perspective illustrated in FIGS. 5 and 6.

It is assumed that surrounding vehicles within the vehicle network coverage of the vehicle broadcasting the message are uniformly distributed.

The vehicle may calculate finally a CBR value using channel state information (e.g., RSSI value or binary information for RSSI, etc.) measured at each distributed antenna illustrated in FIGS. 7 to 9.

First, the vehicle may acquire the channel state information (e.g., RSSI value or binary information for RSSI, etc.) measured at each distributed antenna in order to calculate the CBR value. In this instance, the binary information for the RSSI is information representing the channel state. As illustrated in (a) of FIG. 3, if the RSSI measured during x-time slot is greater than a specific threshold value (e.g., channel clear assessment (CCA)), the binary information is set to a value of ‘1’ representing that the channel is in the busy state.

However, if the measured RSSI is less than the specific threshold value, the binary information for the RSSI is set to a value of ‘0’ representing that the channel is in the idle state.

In this instance, each of the distributed antennas does not perform an operation of calculating the CBR value (0<CBR<1) using the measured RSSI or the binary information for RSSI.

Next, the final CBR value may be calculated by combining the measured RSSI or the binary information for RSSI using the following method.

First, if the CBR value is calculated from the vehicle coverage perspective using RSSI information measured from respective antennas of a synchronized distributed antenna system, the vehicle may select RSSI information with a maximum value among RSSI information collected from each antenna during the x-time slot through the Equation 1, and may calculate binary information representing the idle state/busy state of the channel using the selected RSSI and the specific threshold value (e.g., CCA value).

Afterwards, the CBR value may be finally calculated through the following Equation 2 using the calculated binary information.

$$CBR = \frac{Number of values {}^{′} {1}^{′} in observation duration}{Number of values slots in observation duration} \qquad [ Equation 2 ]$$

That is, as in the above Equation 2, the CBR value may be calculated as a ratio of the number of values ‘1’ observed during a predetermined observation duration. In this case, the predetermined observation duration may consist of a plurality of x-time slots.

Secondly, if the CBR value is calculated from the vehicle coverage perspective using binary information of RSSI acquired from respective antennas of a synchronized distributed antenna system, when at least one binary information of binary information collected from each antenna during the x-time slot has the value of ‘1’ representing the busy state as described above, it is finally determined that the channel state during the x-time slot is the busy state.

Afterwards, the CBR value may be finally calculated through the following Equation 2 using the determined binary information of the channel.

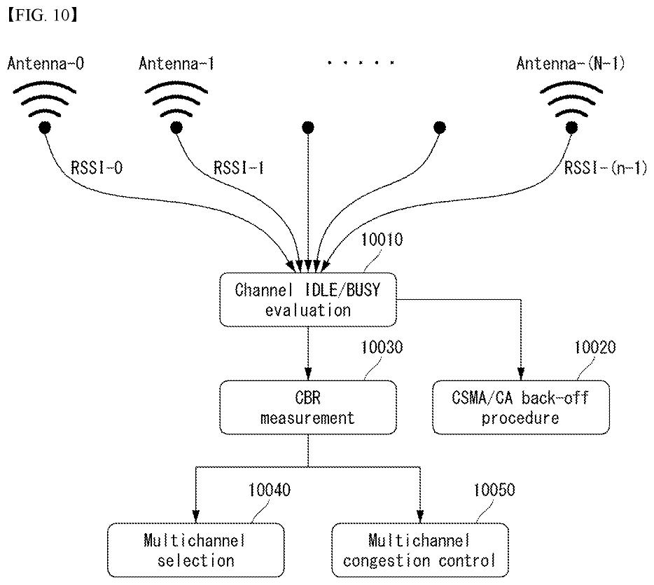

FIG. 10 illustrates an example of a method for multi-channel selection and multi-channel congestion control in a distributed antenna system.

Referring to FIG. 10, the vehicle may perform a multi-channel selection method and a multi-channel congestion control method using CBR information calculated from the vehicle coverage perspective without calculating the CBR value for each channel information measured at each distributed antenna illustrated in FIGS. 8 and 9.

First, since blocks 10010, 10020 and 10030 are the same as the blocks 7010, 7020 and 7030 of FIG. 7, a description thereof is omitted.

A channel selection operation of a multi-channel selection block 10010 for selecting a multi-channel may be performed as described below.

The multi-channel selection block 10010 may select an available channel group having a CBR less than an average CBR for the multi-channel. In other words, the multi-channel selection block 10010 may select channels with a value equal to or less than a threshold value, and the channels may be referred to as the available channel group.

For the channel selection and change operation, a channel candidate group may be additionally selected from the selected available channel group according to a channel candidate group selection process. In an embodiment, the channel candidate group selection process may include a process of selecting one channel candidate group from at least one channel candidate group defined differently based on a service priority. In an embodiment, each channel candidate group among a set of channel candidate groups may be classified based on a channel congestion level, and the channel congestion level may be defined using CBR information. The channel candidate group may be a set of a plurality of channel candidate groups. Each channel candidate group may be defined by sub-grouping channels belonging to the available channel group based on an appropriate rule. In this instance, channels included in each channel candidate group may not overlap each other.

The multi-channel selection block 10040 may select one reference channel from the selected channel candidate group. The reference channel may correspond to a primary channel or a secondary channel. The reference channel may mean a transport channel.

In this instance, CBR information for selecting the available channel group may use CBR information measured from the vehicle coverage perspective described above.

Through this, it may be possible to design a multi-channel selection operation method for a distributed antenna V2X system.

Even if congestion control reference channel selection and congestion control reference CBR are configured in the multi-channel congestion control block 10050 using multi-channel CBR information, it may be possible to design a multi-channel congestion control method for the distributed antenna V2X system by using the CBR value calculated (or measured) from the vehicle coverage perspective described above.

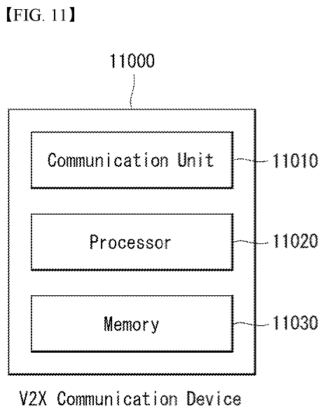

FIG. 11 illustrates a V2X communication device according to an embodiment of the present disclosure.

As illustrated in FIG. 11, a V2X communication device 11000 may include a communication unit 11010, a processor 11020, and a memory 11030. As described above, the V2X communication device may correspond to an on-board unit (OBU) or a road side unit (RSU), or may be included in the OBU or the RSU. The V2X communication device may be included in an ITS station, or may correspond to the ITS station.

The communication unit 11010 may be connected to the processor 11020 to transmit/receive a radio signal or a wired signal. The communication unit 11010 may up-convert data received from the processor 11020 into a transmission/reception band and transmit the signal. The communication unit may implement an operation of an access layer. In an embodiment, the communication unit may implement an operation of a physical layer included in the access layer or may additionally implement an operation of an MAC layer. The communication unit may also include a plurality of sub-communication units to perform communication according to a plurality of communication protocols.

The processor 11020 may be connected to the communication unit 11010 to implement the operation of the layers according to an ITS system or a WAVE system. The processor 11020 may be configured to perform operations according to various embodiments of the present disclosure as described with reference to the drawings. Further, according to various embodiments of the present disclosure, at least one of a module, data, program, or software for implementing the operation of the V2X communication device 11000 may be stored in the memory 11030 and be executed by the processor 11020.

The memory 11030 is connected to the processor 11020 to store a variety of data/information for running the processor 11020. The memory 11030 may be included in the processor 11020 or be installed outside the processor 11020 and connected to the processor 11020 via a known means. The memory may include a secure/non-secure storage device or may be included in a secure/non-secure storage device. According to an embodiment, the memory may be referred to as a secure/non-secure storage device.

The detailed configuration of the V2X communication device 11000 of FIG. 11 may be implemented so that the above-described various embodiments of the present disclosure are applied independently from each other or two or more embodiments thereof are applied together.

In an embodiment of the present disclosure, the communication unit may include at least two transceivers. The communication unit may include a transceiver performing communication according to the WLAN V2X communication protocol based on IEEE (Institute of Electrical and Electronics Engineers) 802.11, and a transceiver performing communication according to the cellular V2X communication protocol based on LTE/E-UTRA (Evolved Universal Terrestrial Access) or 5G NR (New Radio) of 3GPP (3rd Generation Partnership Project). The transceiver that performs communication according to the WLAN V2X communication protocol, such as ITS-G5, may be referred to as a WLAN transceiver. The transceiver that performs communication according to the cellular communication protocol, such as NR, may be referred to as a cellular transceiver.

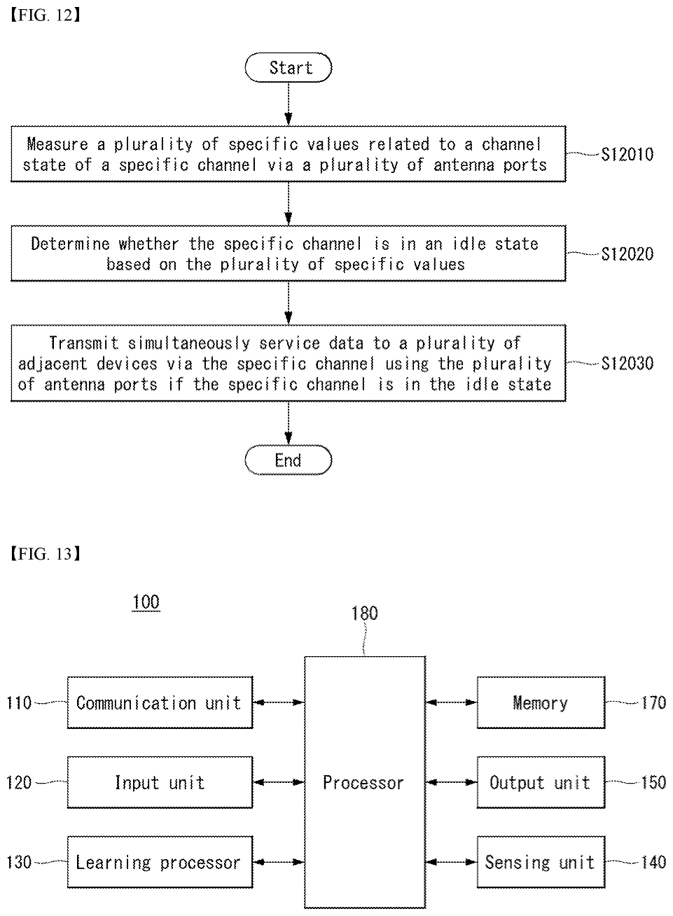

FIG. 12 is a flow chart illustrating a method for transmitting data using a distributed antenna according to an embodiment of the present disclosure.

A V2X communication device may measure a plurality of specific values related to a channel state of a specific channel via a plurality of antenna ports, in S12010.

The plurality of antenna ports are distributed antenna ports illustrated in FIGS. 5 to 10, and may be installed in the V2X communication device at regular intervals or different intervals so that an ideal network coverage is formed from a coverage perspective of the V2X communication device.

The plurality of specific values are values for representing the channel state and may use an RSSI value, etc.

Next, the V2X communication device may determine whether the specific channel is in an idle state based on the plurality of specific values, in S12020.

That is, the V2X communication device may compare each of the plurality of specific values with a threshold value or compare a maximum value with the threshold value in a specific time slot duration to determine whether the specific channel is in the idle state, as in the method illustrated in FIGS. 8 and 9.

If the specific channel is in the idle state, the V2X communication device may simultaneously transmit service data to a plurality of adjacent devices via the specific channel using the plurality of antenna ports, in S12030.

On the other hand, if the specific channel is in a busy state not the idle state, the V2X communication device may perform a back-off procedure through a randomly set back-off value illustrated in FIG. 8 to determine whether the specific channel is in the idle state.

FIG. 13 illustrates an AI device 100 according to an embodiment of the present disclosure.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 13, the terminal 100 may include a communication unit 110, an input unit 120, a learning processor 130, a sensing unit 140, an output unit 150, memory 170 and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

In this case, communication technologies used by the communication unit 110 include a global system for mobile communication (GSM), code division multi access (CDMA), long term evolution (LTE), 5G, a wireless LAN (WLAN), wireless-fidelity (Wi-Fi), Bluetooth™ radio frequency identification (RFID), infrared data association (IrDA), ZigBee, near field communication (NFC), etc.

The input unit 120 may obtain various types of data.

In this case, the input unit 120 may include a camera for an image signal input, a microphone for receiving an audio signal, a user input unit for receiving information from a user, etc. In this case, the camera or the microphone is treated as a sensor, and a signal obtained from the camera or the microphone may be called sensing data or sensor information.

The input unit 120 may obtain learning data for model learning and input data to be used when an output is obtained using a learning model. The input unit 120 may obtain not-processed input data. In this case, the processor 180 or the learning processor 130 may extract an input feature by performing pre-processing on the input data.

The learning processor 130 may be trained by a model configured with an artificial neural network using learning data. In this case, the trained artificial neural network may be called a learning model. The learning model is used to deduce a result value of new input data not learning data. The deduced value may be used as a base for performing a given operation.

In this case, the learning processor 130 may perform AI processing along with the learning processor 240 of the AI server 200.

In this case, the learning processor 130 may include memory integrated or implemented in the AI device 100. Alternatively, the learning processor 130 may be implemented using the memory 170, external memory directly coupled to the AI device 100 or memory maintained in an external device.

The sensing unit 140 may obtain at least one of internal information of the AI device 100, surrounding environment information of the AI device 100, or user information using various sensors.

In this case, sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar.

The output unit 150 may generate an output related to a visual sense, an auditory sense or a tactile sense.

In this case, the output unit 150 may include a display unit for outputting visual information, a speaker for outputting auditory information, and a haptic module for outputting tactile information.

The memory 170 may store data supporting various functions of the AI device 100. For example, the memory 170 may store input data obtained by the input unit 120, learning data, a learning model, a learning history, etc.

The processor 180 may determine at least one executable operation of the AI device 100 based on information, determined or generated using a data analysis algorithm or a machine learning algorithm. Furthermore, the processor 180 may perform the determined operation by controlling elements of the AI device 100.

To this end, the processor 180 may request, search, receive, and use the data of the learning processor 130 or the memory 170, and may control elements of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 may obtain intention information for a user input and transmit user requirements based on the obtained intention information.

In this case, the processor 180 may obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the elements of the AI device 100 in order to execute an application program stored in the memory 170. Moreover, the processor 180 may combine and drive two or more of the elements included in the AI device 100 in order to execute the application program.

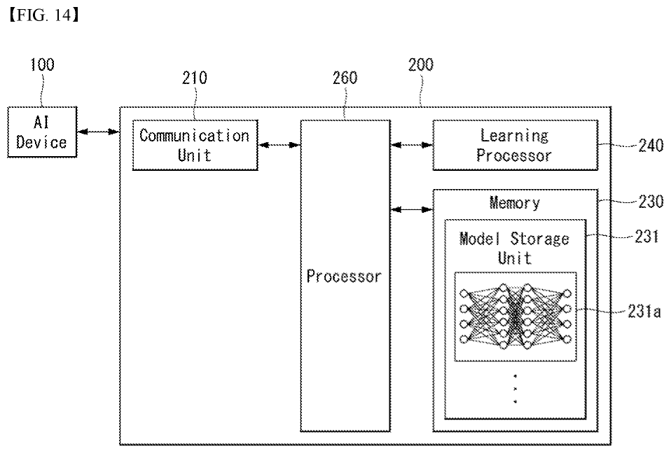

FIG. 14 illustrates an AI server 200 according to an embodiment of the present disclosure.

Referring to FIG. 14, the AI server 200 may mean a device which is trained by an artificial neural network using a machine learning algorithm or which uses a trained artificial neural network. In this case, the AI server 200 is configured with a plurality of servers and may perform distributed processing and may be defined as a 5G network. In this case, the AI server 200 may be included as a partial configuration of the AI device 100, and may perform at least some of AI processing.

The AI server 200 may include a communication unit 210, memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If some of or the entire learning model is implemented as software, one or more instructions configuring the learning model may be stored in the memory 230.

The processor 260 may deduce a result value of new input data using the learning model, and may generate a response or control command based on the deduced result value.

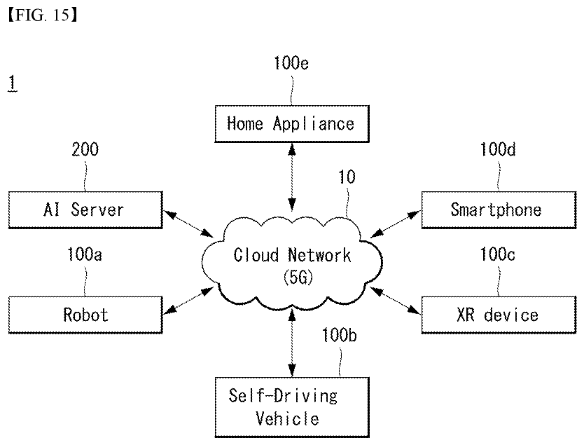

FIG. 15 illustrates an AI system 1 according to an embodiment of the present disclosure.

Referring to FIG. 15, the AI system 1 is connected to at least one of the AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology has been applied may be called AI devices 100a to 100e.

The cloud network 10 may configure part of cloud computing infra or may mean a network present within cloud computing infra. In this case, the cloud network 10 may be configured using the 3G network, the 4G or 1 long-term evolution (LTE) network or the 5G network.

That is, the devices 100a to 100e (200) configuring the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that is, AI devices configuring the AI system 1, over the cloud network 10, and may help at least some of the AI processing of the connected AI devices 100a to 100e.

In this case, the AI server 200 may train an artificial neural network based on a machine learning algorithm in place of the AI devices 100a to 100e, may directly store a learning model or may transmit the learning model to the AI devices 100a to 100e.

In this case, the AI server 200 may receive input data from the AI devices 100a to 100e, may deduce a result value of the received input data using the learning model, may generate a response or control command based on the deduced result value, and may transmit the response or control command to the AI devices 100a to 100e.

Alternatively, the AI devices 100a to 100e may directly deduce a result value of input data using a learning model, and may generate a response or control command based on the deduced result value.

Hereinafter, various embodiments of the AI devices 100a to 100e to which the above-described technology is applied are described. In this case, the AI devices 100a to 100e shown in FIG. 15 may be considered to be detailed embodiments of the AI device 100 shown in FIG. 13.

<AI+Robot>

An AI technology is applied to the robot 100a, and the robot 100a may be implemented as a guidance robot, a transport robot, a cleaning robot, a wearable robot, an entertainment robot, a pet robot, an unmanned flight robot, etc.

The robot 100a may include a robot control module for controlling an operation. The robot control module may mean a software module or a chip in which a software module has been implemented using hardware.

The robot 100a may obtain state information of the robot 100a, may detect (recognize) a surrounding environment and object, may generate map data, may determine a moving path and a running plan, may determine a response to a user interaction, or may determine an operation using sensor information obtained from various types of sensors.

In this case, the robot 100a may use sensor information obtained by at least one sensor among LIDAR, a radar, and a camera in order to determine the moving path and running plan.

The robot 100a may perform the above operations using a learning model configured with at least one artificial neural network. For example, the robot 100a may recognize a surrounding environment and object using a learning model, and may determine an operation using recognized surrounding environment information or object information. In this case, the learning model may have been directly trained in the robot 100a or may have been trained in an external device, such as the AI server 200.

In this case, the robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

<AI+Self-Driving>

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model and perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driving unit.

The map data may include object identification information for various objects disposed in the space (e.g., road) in which the self-driving vehicle 100b runs. For example, the map data may include object identification information for fixed objects, such as a streetlight, a rock, and a building, etc., and movable objects, such as a vehicle and a pedestrian. Furthermore, the object identification information may include a name, a type, a distance, a location, etc.

Furthermore, the self-driving vehicle 100b may perform an operation or may run by controlling the driving unit based on a user's control/interaction. In this case, the self-driving vehicle 100b may obtain intention information of an interaction according to a user' behavior or voice speaking, may determine a response based on the obtained intention information, and may perform an operation.

<AI+XR>

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information for a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information for a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

<AI+Robot+Self-Driving>

An AI technology and a self-driving technology are applied to the robot 100a, and the robot 100a may be implemented as a guidance robot, a transport robot, a cleaning robot, a wearable robot, an entertainment robot, a pet robot, an unmanned flight robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously run along a given flow without control of a user or that autonomously determine a flow and move.

The robot 100a and the self-driving vehicle 100b having the self-driving function may use a common sensing method in order to determine one or more of a moving path or a running plan. For example, the robot 100a and the self-driving vehicle 100b having the self-driving function may determine one or more of a moving path or a running plan using information sensed through a LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

<AI+Robot+XR>

An AI technology and an XR technology are applied to the robot 100a, and the robot 100a may be implemented as a guidance robot, a transport robot, a cleaning robot, a wearable robot, an entertainment robot, a pet robot, an unmanned flight robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

<AI+Self-Driving+XR>

An AI technology and an XR technology are applied to the self-driving vehicle 100b, and the self-driving vehicle 100b may be implemented as a movable type robot, a vehicle, an unmanned flight body, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

When the self-driving vehicle 100b, that is, a target of control/interaction within an XR image, obtains sensor information from sensors including a camera, the self-driving vehicle 100b or the XR device 100c may generate an XR image based on the sensor information. The XR device 100c may output the generated XR image. Furthermore, the self-driving vehicle 100b may operate based on a control signal received through an external device, such as the XR device 100c, or a user's interaction.

A wireless device in the present disclosure may be a base station, a network node, a transmitter UE, a receiver UE, a radio device, a wireless communication device, a vehicle, a vehicle with a self-driving function, a drone (unmanned aerial vehicle (UAV)), an artificial intelligence (AI) module, a robot, an augmented reality (AR) device, a virtual reality (VR) device, an MTC device, an IoT device, a medical device, a FinTech device (or financial device), a security device, a climate/environment device, or a device related to the fourth industrial revolution field or 5G service, or the like. For example, the drone may be an airborne vehicle that flies by a radio control signal without a person being on the flight vehicle. For example, the MTC device and the IoT device may be a device that does not require a person's direct intervention or manipulation, and may include a smart meter, a vending machine, a thermometer, a smart bulb, a door lock, a variety of sensors, or the like. For example, the medical device may be a device used for the purpose of diagnosing, treating, reducing, handling or preventing a disease and a device used for the purpose of testing, substituting or modifying a structure or function, and may include a device for medical treatment, a device for operation, a device for (external) diagnosis, a hearing aid, or a device for a surgical procedure, or the like. For example, the security device may be a device installed to prevent a possible danger and to maintain safety, and may include a camera, CCTV, a black box, or the like. For example, the FinTech device may be a device capable of providing financial services, such as mobile payment, and may include a payment device, point of sales (POS), or the like. For example, the climate/environment device may refer to a device for monitoring and predicting the climate/environment.

Terminals disclosed in the present disclosure may include cellular phones, smart phones, laptop computers, digital broadcast terminals, personal digital assistants (PDAs), portable multimedia players (PMPs), navigators, slate PCs, tablet PCs, ultra-books, wearable devices (e.g., smart watches, smart glasses, head mounted displays (HMDs)), foldable devices, and the like. For example, the HMD refers to a display device worn on the head, and can be used to implement VR or AR.

The embodiments described above are implemented by combinations of components and features of the present disclosure in predetermined forms. Each component or feature should be considered selectively unless specified separately. Each component or feature can be carried out without being combined with another component or feature. Moreover, some components and/or features are combined with each other and can implement embodiments of the present disclosure. The order of operations described in embodiments of the present disclosure can be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be embodied in other specific forms without departing from essential features of the present disclosure. Accordingly, the aforementioned detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

### INDUSTRIAL APPLICABILITY

The present disclosure is used in a series of vehicle communication field.

It is apparent to those skilled in the art that various changes and modifications may be made to embodiments of the present disclosure without departing from the scope or spirit of the present disclosure. Thus, all such changes or modifications are intended to belong to the scope of the present disclosure as defined by the appended claims or equivalents thereof.

1. A method of transmitting data of a V2X communication device, the method comprising:
measuring a plurality of specific values related to a channel state of a specific channel via a plurality of antenna ports,
wherein each of the plurality of specific values is measured via each of the plurality of antenna ports;
determining whether the specific channel is in an idle state based on the plurality of specific values; and
if the specific channel is in the idle state, simultaneously transmitting service data to a plurality of adjacent devices via the specific channel using the plurality of antenna ports.

2. The method of claim 1, further comprising:
if the specific channel is not in the idle state, performing a random back-off procedure.

3. The method of claim 2, wherein the random back-off procedure comprises:
determining whether the specific channel is in the idle state during an arbitrary inter-frame spacing (AIFS) based on a randomly set back-off value;
if the specific channel is in the idle state, reducing the back-off value by a predetermined value; and
if the back-off value is ‘0’, simultaneously transmitting the service data to the plurality of adjacent devices via the specific channel using the plurality of antenna ports.

4. The method of claim 3, wherein the random back-off procedure further comprises:
if the specific channel is not in the idle state, determining again whether the specific channel is in the idle state during the AIFS.

5. The method of claim 1, wherein the plurality of specific values include a received signal strength indication.

6. The method of claim 1, wherein determining whether the specific channel is in the idle state comprises:
comparing each of the plurality of specific values with a threshold value; and
determining that the specific channel is in the idle state based on a result of comparison.

7. The method of claim 6, wherein it is determined that the specific channel is in the idle state when all the plurality of specific values are less than the threshold value.

8. The method of claim 1, wherein determining whether the specific channel is in the idle state comprises:
comparing a largest value of the plurality of specific values with a threshold value; and
if the largest value is less than the threshold value, determining that the specific channel is in the idle state.

9. A V2X communication device comprising:
a memory configured to store data;
an RF unit configured to transmit and receive a radio signal; and
a processor configured to control the memory and the RF unit,
wherein the processor is further configured to:
measure a plurality of specific values related to a channel state of a specific channel via a plurality of antenna ports,
wherein each of the plurality of specific values is measured via each of the plurality of antenna ports;
determine whether the specific channel is in an idle state based on the plurality of specific values; and
if the specific channel is in the idle state, simultaneously transmit service data to a plurality of adjacent devices via the specific channel using the plurality of antenna ports.

10. The V2X communication device of claim 9, wherein the processor is further configured to:
if the specific channel is not in the idle state, performing a random back-off procedure.

11. The V2X communication device of claim 10, wherein the processor is further configured to:
determine whether the specific channel is in the idle state during an arbitrary inter-frame spacing (AIFS) based on a randomly set back-off value;
if the specific channel is in the idle state, reduce the back-off value by a predetermined value; and
if the back-off value is ‘0’, simultaneously transmit the service data to the plurality of adjacent devices via the specific channel using the plurality of antenna ports.

12. The V2X communication device of claim 11, wherein the processor is further configured to:
if the specific channel is not in the idle state, determining again whether the specific channel is in the idle state during the AIFS.

13. The V2X communication device of claim 9, wherein the plurality of specific values include a received signal strength indication.

14. The V2X communication device of claim 9, wherein the processor is further configured to:
compare each of the plurality of specific values with a threshold value; and
determine that the specific channel is in the idle state based on a result of comparison.

15. The V2X communication device of claim 14, it is determined that the specific channel is in the idle state when all the plurality of specific values are less than the threshold value.

16. The V2X communication device of claim 9, wherein the processor is further configured to:
compare a largest value of the plurality of specific values with a threshold value; and
if the largest value is less than the threshold value, determine that the specific channel is in the idle state.
